(19) United States
(12) Patent Application Publication
(10) Pub. No.: US 2017/0085653 A1
(43) Pub. Date: Mar. 23, 2017

(54) METHOD, DEVICE AND SYSTEM FOR MESSAGE DISTRIBUTION

(71) Applicants: Le Holdings (Beijing) Co., Ltd., Beijing (CN); LE SHI INTERNET INFORMATION & TECHNOLOGY CORP., BEIJING, Beijing (CN)

(72) Inventors: Dawei MENG, Beijing (CN); Shuai WANG, Beijing (CN); Zhigang PI, Beijing (CN)

(21) Appl. No.: 15/245,203

(22) Filed: Aug. 24, 2016

Related U.S. Application Data
(63) Continuation of application No. PCT/CN2016/082633, filed on May 19, 2016.

(30) Foreign Application Priority Data
Sep. 22, 2015 (CN) 201510609627.1

(51) Int. Cl. H04L 29/08; H04L 12/58

(52) U.S. Cl. CPC H04L 67/146; H04L 51/046; H04L 67/02

(57) ABSTRACT

Disclosed are a method, a device and a system for message distribution. The method includes: receiving, by a message distributor, an application APP message sent by a message providing platform, the APP message comprising index information regarding to APP online or APP updating; and duplicating the received APP message, and writing a copy of the APP message into each message queue connected to the message distributor, the message queue being a data transmission channel, one end being connected to a terminal service platform, the other end being connected to the message distributor, each terminal service platform separately acquiring the APP message from a message queue connected to the terminal service platform, and then determining, according to the index information, whether the APP message is an APP message required for the terminal service platform.

### CROSS REFERENCE TO RELATED APPLICATIONS

This application is a continuation of International Application No. PCT/CN2016/082633, filed on May 19, 2016, which is based upon and claims priority to Chinese Patent Application No. 201510609627.1, filed on Sep. 22, 2015, the entire contents of which are incorporated herein by reference.

### TECHNICAL FIELD

The present disclosure relates to digital information transmission, and more particularly, to a method, a device and a system for message distribution.

### BACKGROUND

With development of mobile Internet and popularization of smart mobile devices, a growing number of users get used to using terminals to download and install applications (APP). These terminals include but are not limited to: a PC, a mobile phone, a PAD, a TV, a vehicle-mounted device and a wearable device. Users log onto APP stores through the terminals, select and download needed APPs or APP update packages.

At a network side, management of APP stores is implemented by taking a terminal service platform as a back end. Different types of APP stores correspond to different terminal service platforms. For example, mobile phone service platforms are used for management of mobile phone APP stores, and TV service platforms are used for management of TV APP stores, etc. Terminal service platforms receive APP messages sent from a distribution platform, and perform online, updating and offline management on APP products in APP stores according to received APP messages.

In a process when the distribution platform distributes APP messages to terminal service platforms, an existing distribution mechanism is mainly dominated by synchronous distribution, namely, the distribution platform simultaneously or sequentially sends APP messages to multiple terminal service platforms. Such a message distributing mechanism is based on a premise that terminal service platforms are in an available state. If a part of terminal service platforms are paralyzed due to some reasons, some mechanisms such as message resending or message discarding are required to remedy failure of message distribution, thereby leading to complexification of distribution logic at the distribution platform.

For example, in a process of synchronous distribution of messages based on HTTP protocols, when a certain terminal service platform is unable to receive APP messages, the distribution platform needs to determine whether to initiate a message resending mechanism. If the message resending mechanism is initiated, the distribution platform also needs to determine whether to resend APP messages to all terminal service platforms or merely to resend APP messages to those terminal service platforms failed in receiving messages. To the latter manner, in view of a problem of information idempotent, the distribution platform also needs to discard messages resent to terminal service platforms having successfully received messages to avoid repeatedly receiving APP messages; meanwhile, when messages are resent, the distribution logic of the distribution platform is further involved with specific strategies such as opportune moments in resending and number of times in resending, etc. Thus as can be seen, an existing synchronous distribution mechanism needs a set of complex distribution logic to ensure normal distribution of APP messages, which is disadvantageous to implementation of lightweight distribution platform.

### SUMMARY

The present disclosure provides a method, a device and a system for message distribution, which can solve a problem that distribution logic is complex at a distribution platform.

To solve the foregoing technical problem, embodiments of the present disclosure provide following technical solutions.

In a first aspect, embodiments of the present disclosure provide a method for message distribution implemented by a message distributor, including:

receiving an application APP message sent by a message providing platform, the APP message including index information regarding to APP online or APP updating; and

duplicating the received APP message, and writing a copy of the APP message into each message queue connected to the message distributor, the message queue being a data transmission channel, one end being connected to a terminal service platform, other end being connected to the message distributor, each terminal service platform separately acquiring the APP message from a message queue connected to the terminal service platform, and then determining, according to the index information, whether the APP message is an APP message required for the terminal service platform.

In a second aspect, embodiments of the present disclosure further provide an electronic device, including:

at least one processor; and

a memory communicably connected with the at least one processor for storing instructions executable by the at least one processor, wherein execution of the instructions by the at least one processor causes the at least one processor to:

receive an application APP message sent by a message providing platform, the APP message comprising index information regarding to APP online or APP updating;

duplicate the APP message; and

write a copy of the duplicated APP message into each message queue connected to the message distributor, the message queue being a data transmission channel, one end being connected to a terminal service platform, other end being connected to the message distributor, each terminal service platform separately acquiring the APP message from a message queue connected to the terminal service platform, and then determining, according to the index information, whether the APP message is an APP message required for the terminal service platform.

In a third aspect, embodiments of the present disclosure further provide an electronic device, including:

at least one processor; and

a memory communicably connected with the at least one processor for storing instructions executable by the at least one processor, wherein execution of the instructions by the at least one processor causes the at least one processor to:

monitor whether an APP message is written into a message queue, the message queue being a data transmission channel, one end being connected to the terminal service platform, other end being connected to a message distributor; the APP message being a copy of APP message written by the message distributor into each message queue connected to the message distributor through duplication after receiving the APP message sent by a message providing platform, wherein the APP message comprises index information regarding to APP online or APP updating;

read the APP message out from the message queue when monitoring that the APP message is written into the message queue;

determine whether the APP message read to be an APP message required for the terminal service platform according to the index information; and

create or update an APP corresponding to the APP message according to a predetermined processing procedure of the terminal service platform when determining the APP message to be an APP message required for the terminal service platform.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows a flowchart of a message distribution method for a message distributor in accordance with some embodiments;

FIG. 2 shows a flowchart of a message distribution method for a terminal service platform in accordance with some embodiments;

FIG. 3 shows a flowchart of a message distribution method in accordance with some embodiments;

FIG. 4 shows a flowchart of another message distribution method in accordance with some embodiments;

FIG. 5 shows a schematic diagram of a message distribution scenario in accordance with some embodiments;

FIG. 6 is a schematic diagram showing docking between a message queue and a terminal service platform in accordance with some embodiments;

FIG. 7 shows a schematic diagram of an APP message content in accordance with some embodiments;

FIG. 8 shows a block diagram of constitution of a message distributor in accordance with some embodiments;

FIG. 9 shows a block diagram of constitution of another message distributor in accordance with some embodiments;

FIG. 10 shows a block diagram of constitution of a terminal service platform in accordance with some embodiments;

FIG. 11 shows a block diagram of constitution of another terminal service platform in accordance with some embodiments;

FIG. 12 shows a block diagram of constitution of a message distribution system in accordance with some embodiments; and

FIG. 13 shows a block diagram of constitution of an electronic device in accordance with some embodiments.

### DETAILED DESCRIPTION

The following will describe in more detail the exemplary embodiments of the present disclosure with reference to the accompanying drawings. Although the accompanying drawings display the exemplary embodiments of the present disclosure, it should be understood that the present disclosure may be implemented in various forms but not limited by the embodiments set forth herein. Instead, these embodiments are provided to more thoroughly understand the present disclosure, and completely convey the scope of the present disclosure to those skilled in the art.

To solve the problem that a distribution platform is complex in distribution logic, embodiments of the present disclosure provide a message distribution method to implement asynchronous distribution of an APP message by establishing and using a message queue. A message distribution system on which the message distribution method is based relates to following constituent parts: a message providing platform, a message distributor, message queues and a terminal service platform. The message providing platform is an APP message producer, the message distributor is an APP message distributor, a message queue is a data channel connecting the message distributor and the terminal service platform, and the terminal service platform is an APP message receiver.

Before executing embodiments of the present disclosure, a corresponding message queue needs to be established for each terminal service platform. In general, message queues whose quantity is equal to that of terminal service platforms can be created, where one message queue corresponds to one terminal service platform for message distribution. In view of redundant backup of message queues, message queues more than terminal service platforms in quantitative terms can be created. Whereas in view of improving a utilization rate of message queues, message queues less than terminal service platforms in quantitative terms also can be created. After message queues are created, one unique identifier can be assigned to each message queue to distinguish the message queue from other message queues, and the unique identifier can be but not limited to a key value.

After message queues are created for terminal service platforms, message queues corresponding to terminal service platforms need to be bound with the message distributor so that the message distributor sends APP messages to message queues. After created message queues are bound with the message distributor, a corresponding relationship in which one message distributor corresponds to multiple message queues is established, where one end of each message queue is connected to the message distributor, and the other end is connected to a terminal service platform corresponding to the message queue.

Based on the layout of the foregoing message distribution system, embodiments of the present disclosure will describe in detail contents related to message distribution in the following.

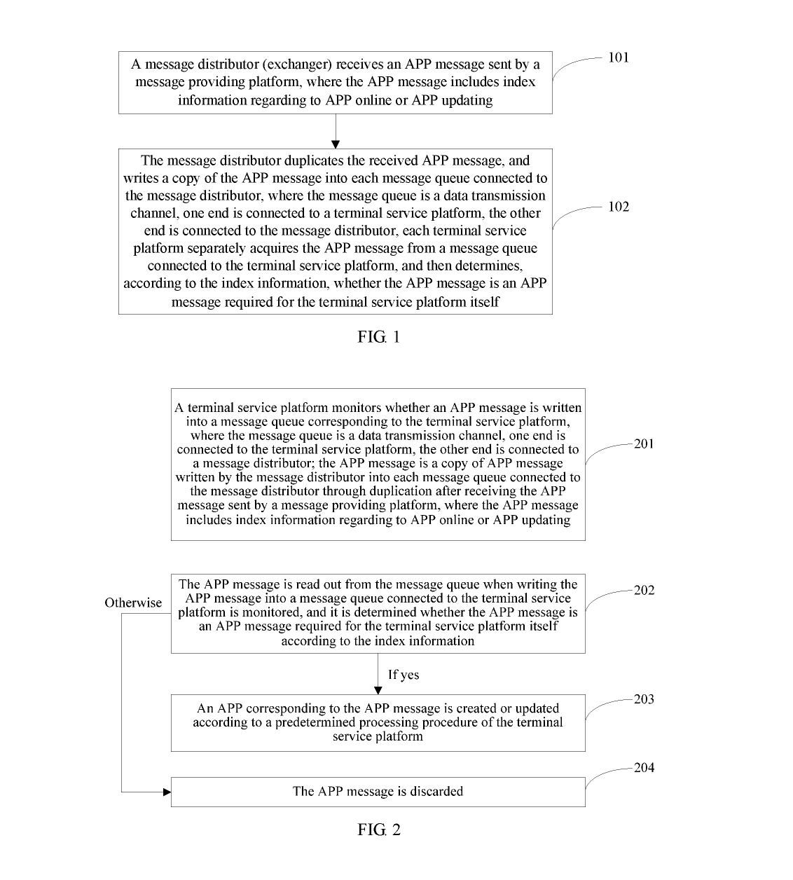

Embodiments of the present disclosure provide a message distribution method which is a method for a message distributor, as shown in FIG. 1, the method includes:

101: Receiving, by a message distributor (exchanger), an APP message sent by a message providing platform, where the APP message includes index information regarding to APP online or APP updating.

It should be explained that the APP message sent by the message providing platform (producer) in this embodiment is index information regarding to APP online or APP updating instead of an APP installation package or an APP update package itself. The index information can be structured index information. An information structure of the index information is not limited in the embodiments of the present disclosure, which can be but not limited to, for example, a json data format.

The index information includes but is not limited to APP identification information and terminal service platform identification information, where the APP identification information uniquely identifies the APP so that the terminal service platform recognizes APP, which may be a package name or an ID of the APP. Specifically, the APP identification information is not limited in embodiments of the present disclosure as long as it uniquely identifies the APP distinguished from other APPs. The terminal service platform identification information uniquely identifies the terminal service platform so that the terminal service platform which receives the APP message recognizes the APP message to determine whether the APP message is an APP message required for the terminal service platform. The terminal service platform identification information may be a name (a Chinese name or an English name) or an ID of the terminal service platform, which is not specifically limited in embodiments of the present disclosure.

In addition to the foregoing APP identification information and the terminal service platform identification information, the index information can further include an operation type of the APP, a version number of the APP and so on, which is not specifically limited in embodiments of the present disclosure.

102: The message distributor duplicates the received APP message, and writes a copy of the APP message into each message queue connected to the message distributor, where the message queue is a data transmission channel, one end is connected to a terminal service platform, the other end is connected to the message distributor, each terminal service platform separately acquires the APP message from a message queue connected to the terminal service platform, and then determines, according to the index information, whether the APP message is an APP message required for the terminal service platform itself.

A terminal service platform includes but is not limited to a mobile phone APP store platform, a TV APP store platform, a game center platform, a smart device APP store platform and an Internet of Vehicles APP store platform or the like, meanwhile, the terminal service platform may further include a third-party developer open platform, an APP search engine and a client. For ease of expression, in subsequent embodiments of the present disclosure, message receivers inclusive of a developer open platform and so on are collectively referred to as terminal service platforms. In addition, with development of trend to service internationalization, to prevent intercontinental network delay between domestic terminal service platforms and overseas terminals, more and more terminal service platforms are deployed overseas. APP message receivers in this embodiment further include terminal service platforms having different language versions deployed overseas.

The message queue is a queue created by a terminal service platform for temporarily storing APP messages. In this step, the message distributor can establish multiple message queues through but not limited to method invocation, and respectively write APP messages pushed by the message providing platform into the multiple message queues. When the multiple message queues are established, the message distributor can establish message queues whose quantity is equal to that of terminal service platforms, where one terminal service platform corresponds to one message queue. When one terminal service platform corresponds to one message queue and the quantity of the terminal service platforms increases or decreases, the message distributor establishes or releases message queues that correspondingly increase or decrease terminal service platforms. Further, to reduce resource cost generated by establishing/releasing message queues, in the case where the quantity of the terminal service platforms decreases, the message distributor can also temporarily maintain message queues corresponding to the terminal service platforms, and when new terminal service platforms are added, to-be-used message queues are distributed to the newly-added terminal service platforms.

It should be explained that the “one terminal service platform corresponds to one message queue” in this embodiment is not a sufficient and necessary condition for the “quantity of terminal service platforms is equal to that of message queues”. As previously mentioned, the quantity of message queues can be more than, less than or equal to that of terminal service platforms. When the quantity of message queues is more than that of terminal service platforms, surplus message queues neither are connected to any terminal service platform nor participate in distribution of APP messages but merely are used as backup. When the quantity of message queues is less than that of terminal service platforms, surplus terminal service platforms can use message queues having been used by the other terminal service platforms for receiving messages after the other terminal service platforms receives APP messages. At the moment, it is only needed to change a binding connection relation between message queues and terminal service platforms. In such a case, the same message queue can be successively bound and connected with different terminal service platforms for message sending. However, no matter what a quantitative relation is between message queues and terminal service platforms, when messages are received, terminal service platforms receiving APP messages correspond to a message queue. However, this neither represents all the terminal service platforms correspond to a message queue at the same time nor represents a binding connection is implemented between all the message queues and the terminal service platforms.

In this embodiment, in allusion to different APPs required for different terminal service platforms, the message providing platform can send different APP messages to different terminal service platforms. When the message providing platform generates an APP message, a terminal service platform identification and an APP identification corresponding to the APP message can be added into the APP message so that a receiver can recognize. When the message distributor receives an APP message sent by the message providing platform, the APP message is not recognized to determine that the APP message belongs to which terminal service platform instead the APP message is duplicated to obtain APP messages whose quantity is equal to that of message queues connected to the message distributor, and the APP messages obtained by duplication are respectively written into each message queue.

Exemplarily, four terminal service platforms A, B, C and D respectively correspond to message queues a, b, c and d; supposing the message providing platform needs to send an APP message 1 and an APP message 2 to the terminal service platform A and send an APP message 3 to the terminal service platform B, the message distributor may respectively duplicate four copies of the APP messages 1, 2 and 3, and then write them into the message queues a, b, c and d so that the APP messages 1, 2 and 3 are respectively stored in the message queues a, b, c and d.

Embodiments of the present disclosure provide a message distribution method which is a method for a terminal service platform, as shown in FIG. 2, the method includes:

201: A terminal service platform monitors whether an APP message is written into a message queue corresponding to the terminal service platform, where the message queue is a data transmission channel, one end is connected to the terminal service platform, the other end is connected to a message distributor; the APP message is a copy of APP message written by the message distributor into each message queue connected to the message distributor through duplication after receiving the APP message sent by a message providing platform, where the APP message includes index information regarding to APP online or APP updating.

Based on the message providing platform, all APP messages for all terminal service platforms are pushed to the message distributor, and the message distributor may indistinctively write all the APP messages into all the message queues connected to the message distributor. Each terminal service platform may monitor a corresponding message queue, when it is monitored that a new message occurs in the message queue, operations in Steps 202-204 are executed.

202: Reading the APP message out from the message queue when writing the APP message into a message queue connected to the terminal service platform is monitored, and determining whether the APP message is an APP message required for the terminal service platform according to the index information; Step 203 is executed if the APP message is determined to be an APP message required for the terminal service platform itself, otherwise Step 204 is executed.

According to related content in Step 101, when the message providing platform sends an APP message, a terminal service platform identifier and an APP identifier corresponding to the APP message can be packaged into the APP message for recognition by an APP message receiver. In the embodiments of the present disclosure, the APP message is read out from the message queue when writing the APP message into a message queue corresponding to the terminal service platform is monitored, the APP message is parsed to acquire index information included in the APP message, where the index information includes APP identification information and terminal service platform identification information. The acquired terminal service platform identification information is compared with identification information of the terminal service platform, the APP message is determined to be an APP message required for the terminal service platform when the terminal service platform identification information is consistent with the identification information of the terminal service platform, otherwise the APP message is determined not to be an APP message required for the terminal service platform.

In an example as shown in FIG. 1, the terminal service platforms A-D may receive the APP messages 1-3. To the terminal service platform A, the terminal service platform identifier of the terminal service platform A is parsed out respectively from the APP messages 1 and 2, thus the APP messages 1 and 2 are determined to be APP messages required for the terminal service platform A, whereas a terminal service platform identifier parsed out from the APP message 3 is the identifier of the terminal service platform B, and thus the APP message 3 is determined not to be an APP message required for the terminal service platform A. In the same way, merely the APP message 3 is determined to be an APP messages required for the terminal service platforms, whereas APP message 1-3 are respectively determined to be APP messages not required for the terminal service platforms C and D.

203: Creating or updating an APP corresponding to the APP message according to a predetermined processing procedure of the terminal service platform.

When an APP message includes identification information of a terminal service platform and identification information of an APP, the creating or updating an APP corresponding to the APP message according to a predetermined processing procedure of the terminal service platform specifically includes: creating or updating an APP corresponding to the APP message according to the predetermined processing procedure of the terminal service platform, requesting to acquire APP Android application package APK information corresponding to the APP identification information according to the predetermined processing procedure of the terminal service platform; and performing online processing or updating on the APP corresponding to the APP identification information according to the APK information.

In the embodiment as shown in FIG. 1, the message providing platform and the message distributor respectively play a part of a message producer and a message exchanger (namely, the producer and the exchanger as mentioned in the forgoing Step 101). In this step, when the terminal service platform performs online processing or updating on the APP corresponding to the APP identification information according to the APK information, the terminal service platform plays a part of a message consumer.

204: Discarding the APP message.

In this embodiment, a corresponding message queue is established for each terminal service platform, and when the message providing platform needs to send an APP message, a copy of identical APP message is directly sent by the message distributor to each message queue corresponding to a terminal service platform. This manner of sending an APP message to a message queue belongs to an indistinctive sending because the APP message can be sent to a connected message queue as long as the message queue is connected to the message distributor. Therefore, no attention needs to be paid to specific strategies such as a distribution object or a distribution manner when this message distribution method is used, and thus the message distribution method is simple and easy for operation, thereby avoiding a complex logic in sending an APP message by the message providing platform.

Based on a fact that a message queue has a characteristic of message persistence, after an APP message is sent to a message queue, the APP message can be temporarily stored in each message queue. Each terminal service platform may monitor a message queue corresponding to the terminal service platform. Only when it is monitored that a message queue has an APP message is the APP message extracted from the message queue. Therefore, when an APP message is sent out but a corresponding terminal service platform works improperly and thus is unable to successfully receive the APP message, it is unnecessary to deploy complex strategies such as message resending and message discarding or the like. In addition, when each terminal service platform monitors that a message queue corresponding to the terminal service platform has APP messages, the terminal service platform may recognize APP messages, and only process APP messages required for the terminal service platform. In this way, recognition and classification of APP messages are performed at the terminal service platform, which reduces logic of distributing messages by the message providing platform to a certain extent. To sum up, compared with a synchronous distribution mechanism in the prior art, the present disclosure can greatly simplify distribution logic for a distribution platform and implement a lightweight design of the distribution platform.

In this embodiment, after an APP message is sent to a message queue corresponding to each terminal service platform, the process is mutually independent for each terminal service platform to receive an APP message from a message queue corresponding to the terminal service platform. Each terminal service platform can flexibly determine message receiving time according to actual situation, and it is unnecessary for each terminal service platform to simultaneously start or finish receiving an APP message. Meanwhile, since each terminal service platform receives an APP message based on a message queue of its own, when certain a or a few terminal service platforms are in an unavailable state, this does not affect other terminal service platforms from normally receiving APP messages. In essence, independence and anti-interference in message receiving are greatly improved.

In addition, the method has following advantages:

1. Asynchronous characteristic: a distribution platform in the prior art uses a synchronous mechanism to distribute an APP message. The synchronous distribution mechanism may have two specific implementations: 1. establishing multithreading and sending messages to multiple terminal service platforms; 2. successively sending messages to each terminal service platform. When the quantity of terminal service platforms in the system increases, to the former implementation, concurrency resource cost of the distribution platform needs to increase; and to the latter implementation, message distributing time may be extended. In this method, establishment of a message queue can be implemented by means of simple method invocation, and message distribution for multiple message queues is performed concurrently. No matter how the quantity of terminal service platforms increases, the terminal service platform only needs to transmit an APP message once. Therefore, compared with the prior art, the method can greatly reduce concurrency resource cost and shorten distribution time consumption.

2. Flexibility: in the prior art, the distribution logic of the distribution platform needs to be changed if the quantity of terminal service platforms increases or decreases, which is complex and time-consuming in implementation, and message distribution has certain hysteresis. In the present disclosure, establishment and releasing of a message queue can be implemented by means of simple method invocation. Compared with the prior art, the method can flexibly and conveniently increase or decrease the quantity of terminal service platforms and ensure timely distribution of APP messages.

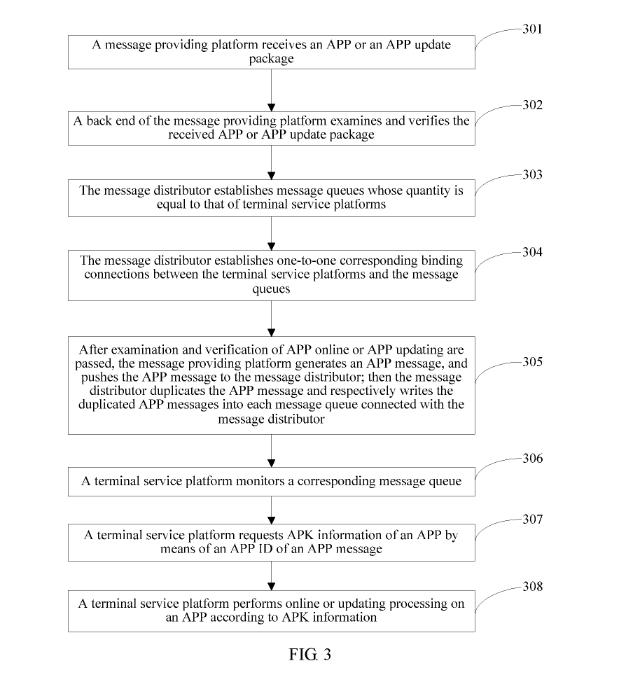

Further, another embodiment of the present disclosure also provides a message distribution method. Based on establishing, by a message distributor, message queues whose quantity is equal to that of terminal service platforms, as shown in FIG. 3, the method includes:

301: A message providing platform receives an APP or an APP update package.

The message providing platform receives a new APP or APP update package reported by a developer platform. The developer platform in this embodiment includes an internal developer platform of a content provider or a third-party developer open platform. The APP or the APP update package received in this step also can be an APP acquired on a webpage or a third-party APP store by means of computer programming tools, for example, an APP or APP update package captured by means of APP crawler tools. This embodiment does not limit sources of the APP or the APP update package.

302: A back end of the message providing platform examines and verifies the received APP or APP update package.

The message providing platform can automatically examine and verify the APP or APP update package by means of a machine model at the back end, or provide a manual examination and verification function for operation and maintenance staff through a human-computer interaction interface at a front end of the platform, or combine an automatic examination and verification mechanism with a manual examination and verification mechanism, which are not limited in this embodiment.

In addition, the message providing platform can also segment a task of APP examination and verification out, the examination and verification are performed by other platforms independent of the message providing platform, and the message providing platform merely receives a result of examination and verification.

303: The message distributor establishes message queues whose quantity is equal to that of terminal service platforms.

304: The message distributor establishes one-to-one corresponding binding connections between the terminal service platforms and the message queues.

Each message queue has a unique identifier distinguishing from other message queues. In this embodiment, the message distributor can bind a key value assigned in advance to a terminal service platform with a message queue, thereby implementing a binding connection between the terminal service platform and the message queue.

Before message distribution, the message distributor needs to assign a key value having a unique identifier to a terminal service platform, where the key value is configured to uniquely identify a message queue corresponding to the terminal service platform. In practical application, a key value can be a string of character string whose length is not limited, and a concrete form thereof can be a name of the terminal service platform or a platform ID, or merely is a code in a purely digital form, the concrete form of the key value is not limited in this embodiment.

In practical application, the message distributor can maintain a key value list at a back end. When the quantity of terminal service platforms increases or decreases, the message distributor can perform update operation on the list, for example addition, deletion, modification or examination, etc.

In this embodiment, the message distributor establishes multiple message queues by means of method invocation, and binds different key values for different message queues, thereby establishing a one-to-one mapping relation among a key value, a terminal service platform and a message queue.

In one implementation of this embodiment, the message distributor can invoke an ftok function to acquire an Inter-Process Communication (IPC) key value related to message distribution, and then establish a relatively unique key value compared with the IPC key value, where the key value is a key value corresponding to a terminal service platform. Afterward, the message distributor invokes an msgget function, creates a message queue through the key value, and achieves establishing a message queue and binding the key value.

In this embodiment, there are two opportune moments for the message distributor to establish a binding connection. Moment I: a binding connection between a terminal service platform and a message queue is established during initialization of a distribution platform; and Moment II: when a new terminal service platform is added, a binding connection between the newly-added terminal service platform and a message queue is established.

It should be explained that in practical application Steps 303-304 can be first executed to establish a message queue, then Steps 301-302 are executed to examine and verify an APP, alternatively, Steps 301-302 and Steps 303-304 are simultaneously executed. The flow sequence as shown in FIG. 3 merely is an implementation of this embodiment, in practical application, it is advisable as long as Steps 301-302 are completed before execution of Step 305.

305: After examination and verification of APP online or APP updating are passed, the message providing platform generates an APP message, and pushes the APP message to the message distributor; then the message distributor duplicates the APP message and respectively writes the duplicated APP messages into each message queue connected with the message distributor.

A distribution process involves with multiple terminal service platforms and multiple message queues, and APP messages distributed into each message queue are identical, namely, one APP message needs to be distributed to all message queues. Therefore, in this step, a to-be-distributed APP message needs to be duplicated to acquire multiple copies of identical APP messages. In an implementation, duplication of messages is finished by the message distributor, the message providing platform sends an APP message once to the message distributor, the message distributor duplicates the APP message sent by the message providing platform to be multiple copies of identical APP messages through a fanout technology, the number of copies of fanout APP messages is equal to the quantity of message queues, then the message distributor invokes an msgsnd function to respectively write a copy of APP message into each message queue.

306: A terminal service platform monitors a corresponding message queue.

As previously mentioned, APP messages received by terminal service platforms are identical, including all APP messages sent to terminal service platforms. Each terminal service platform monitors a corresponding message queue. When a new APP message is written into a message queue, a terminal service platform receives and parses the APP message, acquires an ID for identifying the message from the APP message, and determines whether the APP message is an APP message required for the terminal service platform according to the ID. When the APP message is an APP message required for the terminal service platform, the terminal service platform executes Step 307 and Step 308, and processes the APP message according to a processing logic which is used by the terminal service platform to process an APP message. When the APP message is not an APP message required for the terminal service platform, the terminal service platform discards the APP message.

In one implementation of this embodiment, the foregoing ID can be a platform ID of a terminal service platform, and the platform ID can uniquely identify the terminal service platform. Before pushing an APP message to the message distributor, the message providing platform adds, into the APP message, the platform ID of a terminal service platform receiving the APP message. A terminal service platform parses out an ID from an APP message. The APP message is processed when the platform ID is a platform ID of the terminal service platform itself. The APP message is discarded when the platform ID is a platform ID of another terminal service platform.

307: A terminal service platform requests APK information of an APP by means of an APP ID of an APP message.

According to Step 101 in FIG. 1, the APP message is packaged with identification information of a terminal service platform corresponding to the APP message and identification information of the APP message. When an APP message in a message queue is an APP message required for a terminal service platform, the terminal service platform parses an APP ID from the APP message, and reports the APP ID to acquire Android Package (APK) information of the APP. In this embodiment, the APP ID shall uniquely identify the APP. In practical application, an APP name or an APP version number can be used as an APP ID, or more preferably, both of them are combined for use.

After receiving an APP ID reported by the terminal service platform, the message providing platform searches for the APK information of the corresponding APP hereby, and sends the searched APK information to the terminal service platform.

In practical application, APK information specifically can be at least one of following information: APP classification, APP metadata, APP installation package, APP update package, APP version number, APP download history, APP adapter system/machine model, APP tag, comment, praise information, developer information, user information and internationalization information.

308: A terminal service platform performs online or updating processing on an APP according to APK information.

After receiving the APK information, the terminal service platform online provides the APK information to an APP store for a user to view and select, thereby completing the whole online process of an APP or an APP update package.

Further, in allusion to failure of receiving an APP message, another embodiment of the present disclosure further provides a message persistence mechanism. In this embodiment, after successfully monitoring and receiving an APP message, a terminal service platform can send, to a message queue, an acknowledgment response representing the message is received successfully. According to the response, the message queue deletes the APP message successfully received by the terminal service platform from the message queue. However, when the terminal service platform is unable to receive an APP message because it is in an unavailable state or because of other reasons, the terminal service platform may send, to a message queue, a negative acknowledgment response representing the message is received unsuccessfully. According to the response, the message queue persistently saves the APP message received unsuccessfully in the message queue to wait for subsequent receiving again by a terminal service platform. In practical application, an ACK signaling and an NACK signaling can be respectively used as an acknowledgment response and a negative acknowledgment response.

Still further, in view of a fact that persistently saving an APP message may infinitely increase resource cost of a distribution platform. Therefore, another embodiment of the present disclosure further provides a message persistence mechanism that also gives consideration to platform resource cost. In this embodiment, the message distributor may use following two manners to improve a message preservation mechanism:

Manner I:

A timer is independently set for each message written into a message queue. If time is up for the timer of a certain message but the message has not been sent out yet, the message is deleted by the message distributor from the message queue. If no message is saved in the message queue from which the message is deleted, the message distributor releases the message queue.

In addition, the message distributor may set a global timer for a message queue. When time is up for the timer, if the message queue still saves at least one message, the message distributor empties all messages and releases the message queue.

Manner II:

An upper limit of total data volume of messages saved is set for a message queue. If the sum of data sizes of all messages stored in message queues exceeds the upper limit of total data volume, the message distributor deletes messages saved in message queues according to a sequence where preservation time is from long to short by taking a timing sequence as a basis until the sum of data sizes of remaining messages is lower than the upper limit of total data volume. Of course, the message distributor may empty all messages and release the message queue at one go.

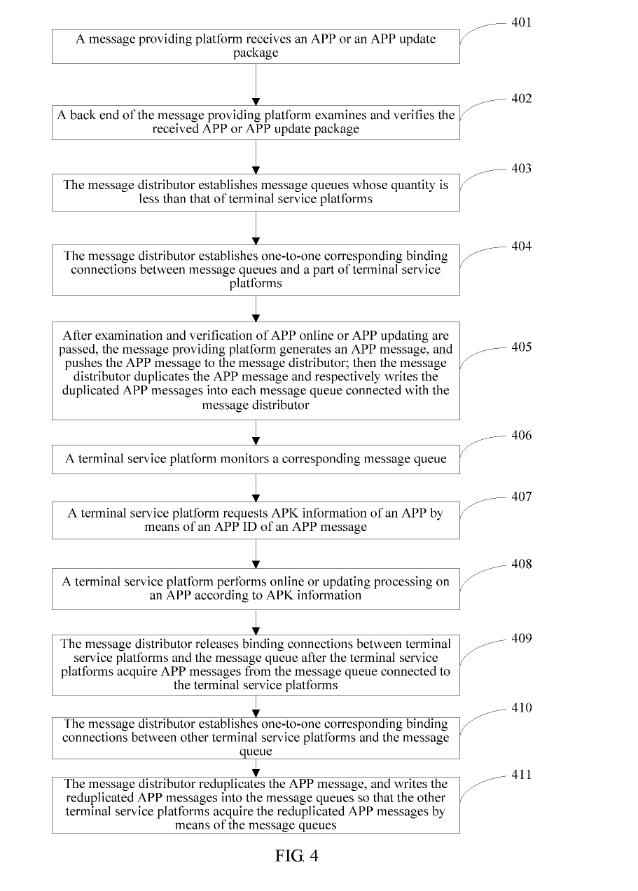

The embodiment as shown in FIG. 3 provides an implementation where the quantity of message queues is equal to that of terminal service platforms. In the following, another embodiment of the present disclosure will provide an implementation for reusing a message queue based on a case where the quantity of message queues is less than that of terminal service platforms. As shown in FIG. 4, the method of the implementation includes:

401: A message providing platform receives an APP or an APP update package.

402: A back end of the message providing platform examines and verifies the received APP or APP update package.

403: The message distributor establishes message queues whose quantity is less than that of terminal service platforms.

Implementations of Steps 401-403 in this embodiment are respectively corresponding and identical to implementations of Steps 301-303 in FIG. 3, and the only difference resides in that the quantity of message queues established in Step 403 is less than that of terminal service platforms. For example, three message queues are established for five terminal service platforms, or two message queues are established for six terminal service platforms. This embodiment does not limit quantity difference between message queues and terminal service platforms. In extreme circumstances, only one message queue is established for any number of terminal service platforms. 404: The message distributor establishes one-to-one corresponding binding connections between message queues and a part of terminal service platforms.

Since the quantity of the message queues is limited, message distribution for a part of terminal service platforms is achieved first only through limited message queues. Correspondingly, binding connections need to be established first between the message queues and this part of terminal service platforms. In this embodiment, the quantity of a part of terminal service platforms depends on the quantity of message queues, for example, when four message queues are established for seven terminal service platforms, first of all, four terminal service platforms are bound onto four message queues.

In this embodiment, rules for selecting a first batch of terminal service platforms may be determined according to a terminal identification law, for example, an identification sorting order, a priority corresponding to identification types and so on; the rules for selecting a first batch of terminal service platforms may also be determined by tolerance of a terminal service platform to user service delay; or the rules for selecting a first batch of terminal service platforms may also be manually determined by operation and maintenance staff according to an actual operation strategy, which are not limited in this embodiment.

An implementation mode of this step is the same as that of Step 404 in FIG. 3, and thus is not unnecessarily described herein.

405: After examination and verification of APP online or APP updating are passed, the message providing platform generates an APP message, and pushes the APP message to the message distributor; then the message distributor duplicates the APP message and respectively writes the duplicated APP messages into each message queue connected with the message distributor.

406: A terminal service platform monitors a corresponding message queue.

407: A terminal service platform requests APK information of an APP by means of an APP ID of an APP message.

408: A terminal service platform performs online or updating processing on an APP according to APK information.

Implementations of Steps 405-408 are respectively corresponding and identical to implementations of Steps 305-308 in FIG. 3, and the difference resides in that receiving and processing APP messages are implemented only for the first batch of terminal service platforms by the end of Step 408, and receiving and processing APP messages are implemented for the remaining terminal service platforms by subsequent steps from Step 409.

409: The message distributor releases binding connections between terminal service platforms and the message queue after the terminal service platforms acquire APP messages from the message queue connected to the terminal service platforms.

410: The message distributor establishes one-to-one corresponding binding connections between other terminal service platforms and the message queue.

The terminal service platforms in Step 409 are the first batch of terminal service platforms bound with the message queues and receiving APP messages, whereas the other terminal service platforms in Step 410 are the remaining terminal service platforms to be established binding connections with the message queues. In Step 409, the message distributor may delete, from a message queue, a key value of a previously-bound terminal service platform by means of a reverse engineering function of an msgget function, thereby releasing binding connections between the first batch of terminal service platforms and the message queues. It should be explained that after the binding connections in this embodiment are released, message queues still exist, and releasing binding connections is not equivalent to releasing message queues.

In this embodiment, an implementation of Step 410 is the same as that of Step 404, and thus is not unnecessarily described herein.

411: The message distributor reduplicates the APP message, and writes the reduplicated APP messages into the message queues so that the other terminal service platforms acquire the reduplicated APP messages by means of the message queues.

After binding connections between the message queues and the remaining terminal service platforms are completed, the message distributor reduplicates the to-be-distributed APP message according to the implementation in Step 405, and then respectively writes reduplicated multiple copies of identical APP messages into each message queue so as to be received and processed by the remaining terminal service platforms.

In the following, an application scenario of the embodiments of the present disclosure is provided with combination of the method as shown in FIG. 3 or FIG. 4. FIG. 5 shows a schematic scenario diagram integrating APP uploading, APP examination and verification and APP message distribution. The scenario includes following objects:

1. APP crawler tool;

2. Developer open platform;

3. TV APP store platform;

4. Game center platform;

5. Mobile phone APP store platform;

6. Client;

7. Smart device APP store platform;

8. Internet of Vehicles APP store platform;

9. Enterprise Management Information System OMS;

10: qpid message queue;

11: ka (king-arthur);

12: elastic-search;

13: redis; and

14: Database.

The APP crawler tool and the developer open platform belong to sources of an APP or an APP update package and are configured to provide a to-be-online APP or APP update package; the TV APP store platform, the game center platform, the smart device APP store platform and the Internet of Vehicles APP store platform serve as terminal service platforms for receiving APP messages by means of message queues. It is worth noting that the client in FIG. 5 has requirements for log analysis and data statistics, the developer open platform has requirements for APP online information feedback, and the elastic-search needs to synchronize the latest APK information so that a user makes a search, and thus is similar to the terminal service platforms. They also play a part in receiving APP messages. The qpid message queue includes a message distributor configured to establish a message queue, assign a key value and write an APP message; the ka, the redis and the database interact for providing APK information of an APP for a terminal service platform; and the OMS takes charge of overall operation and maintenance management.

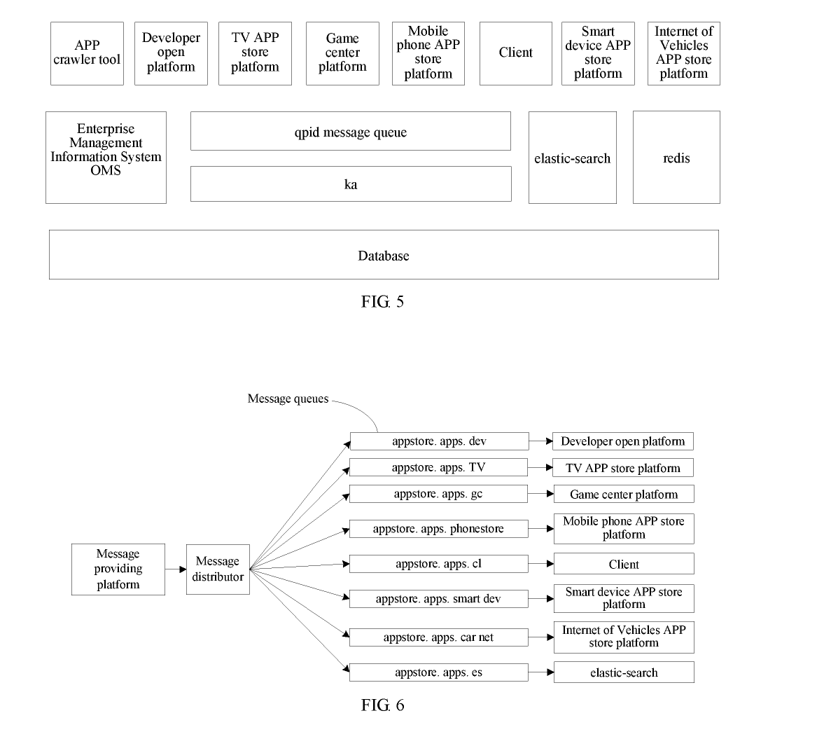

In the scenario as shown in FIG. 5, the APP crawler tool or the developer open platform reports an APP or an APP update package for examination and verification. After the examination and verification are passed, the qpid message queue establishes eight message queues, respectively corresponding to eight terminal service platforms inclusive of the developer open platform and the TV APP store platform, etc. FIG. 6 is a schematic diagram showing docking between a message queue and a terminal service platform, in FIG. 6, a key value is assigned for a combination of each pair of message queue and terminal service platform. By means of each message queue, each terminal service platform receives APP messages distributed by the message distributor through a message queue.

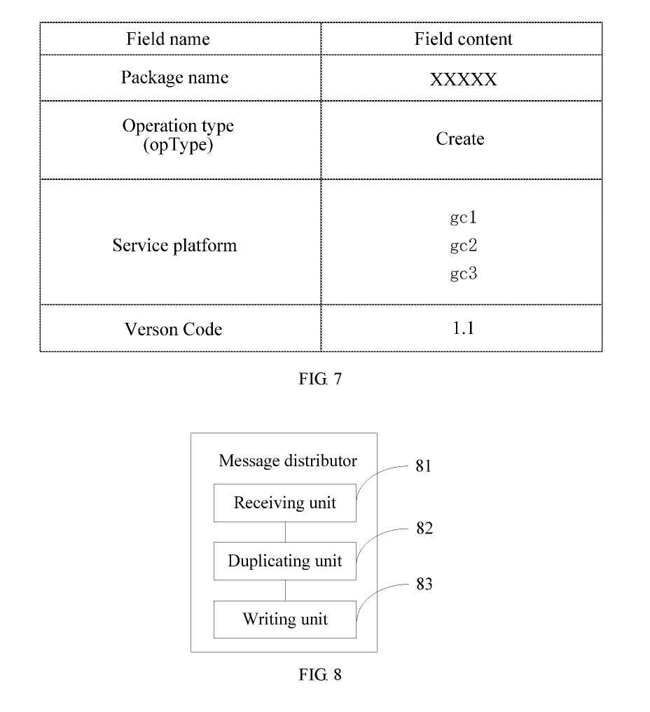

Further, with combination of the scenario as shown in FIG. 5, another embodiment of the present disclosure performs an exemplary description on a concrete form of an APP message. As shown in FIG. 7, a structured field of an APP message includes: a package name field, an operation type (opType) field, a service platform field and a version number (Verson Code) field. The package name field is configured to record an APP name; information recorded in an operation type field includes Update and Create, where Update represents APP update, and Create represents APP online; the service platform field records a platform ID of a terminal service platform; and the version number field records the latest version of an APP.

After receiving an APP message as shown in FIG. 7, a terminal service platform parses the APP message, and determines whether the APP message needs to be reserved according to a platform ID recorded in the service platform field. In FIG. 7, the service platform field records three platform IDs “gc1”, “gc2” and “gc3”, which indicate that the APP message shall be received by three terminal service platforms, namely, a game center platform 1, a game center platform 2 and a game center platform 3. Alternatively, if the service platform field is null, this indicates the APP message shall be received by all the terminal service platforms. After acquiring an APP message that shall be reserved, a terminal service platform reads the name and version number of the APP from the package name field and the version number field of the APP message, and reports an APP ID (a combination of the name and the version number) to the message providing platform. Alternatively, the version number field being null indicates the APP is the currently latest version. After receiving the name and version number of the APP, the distribution platform searches for a corresponding APP and sends APK information of the APP to a terminal service platform by means of ka. The ka can request to acquire the APK information from the database when a terminal service platform reports the APP ID, or cache the requested APK information by means of redis so that number of times of accessing the database can be reduced when the APK information is fed back subsequently. After receiving the APK information, the terminal service platform online provides the APK information to an APP store, thereby completing the whole APP online process.

In this embodiment, different formats can be adopted for an APP message, but more preferably, the APP message shall be set as a jason format. Compared with a traditional message format (for example, a binary format), the jason format, as a lightweight data interchange format, is characterized by visualization and is easy for a programmer to check and write. Meanwhile, compared with a traditional data interchange format such as the binary format, the jason format is unnecessary for compiling and converting, and thus is easy for parsing by a machine. Exemplarily, an APP message of the jason format has a following form:

{“PackageName”: “wb.gc.zzx.axc”, “opType”: “Update”, “Platform”: “gc1”, “VersonCode”: “1.0”}

Further, another embodiment of the present disclosure further provides a message distributor. As shown in FIG. 8, the message distributor includes: a receiving unit 81, a duplicating unit 82 and a writing unit 83, where

the receiving unit 81 is configured to receive an application APP message sent by a message providing platform, the APP message includes index information regarding to APP online or APP updating;

the duplicating unit 82 is configured to duplicate the APP message received by the receiving unit 81; and

the writing unit 83 is configured to write a copy of APP message duplicated by the duplicating unit 82 into each message queue connected to the message distributor, where the message queue is a data transmission channel, one end thereof is connected to a terminal service platform, and the other end is connected to the message distributor, each terminal service platform separately acquires an APP message from a message queue connected to the terminal service platform, and then determines, according to the index information, whether the APP message is an APP message required for the terminal service platform itself.

Further, as shown in FIG. 9, the message distributor further includes:

an establishing unit 84, configured to establish a one-to-one corresponding binding connection between a terminal service platform and a message queue before the duplicating unit 82 duplicates the received APP message and the writing unit 83 writes a copy of APP message duplicated by the duplicating unit 82 into each message queue connected to the message distributor, where each message queue has a unique identifier distinguishing from other message queues.

Further, the establishing unit 84 is configured to initialize establishment of a binding connection with a message queue and add establishment of a binding connection with the message queue.

Further, the duplicating unit 82 is configured to fan an APP message out to be multiple copies of identical APP messages through a fanout mode, where number of copies of the APP messages fanned out is equal to a quantity of message queues; and

the writing unit 83 is configured to separately write a copy of APP message into each message queue connected to the message distributor.

Further, as shown in FIG. 9, the message distributor further includes:

a releasing unit 85, configured to release a binding connection established by the establishing unit 84 between a terminal service platform and a message queue after the terminal service platform acquires an APP message from the message queue connected to the terminal service platform; and

the establishing unit 84, configured to establish one-to-one corresponding binding connections between other terminal service platforms and the message queue.

Further, the duplicating unit 82 is configured to reduplicate the APP message after the establishing unit 84 establishes one-to-one corresponding binding connections between other terminal service platforms and the message queue; and

the writing unit 83 is configured to write the APP message reduplicated by the duplicating unit 82 into the message queue so that the other terminal service platforms acquire the reduplicated APP message by means of the message queue.

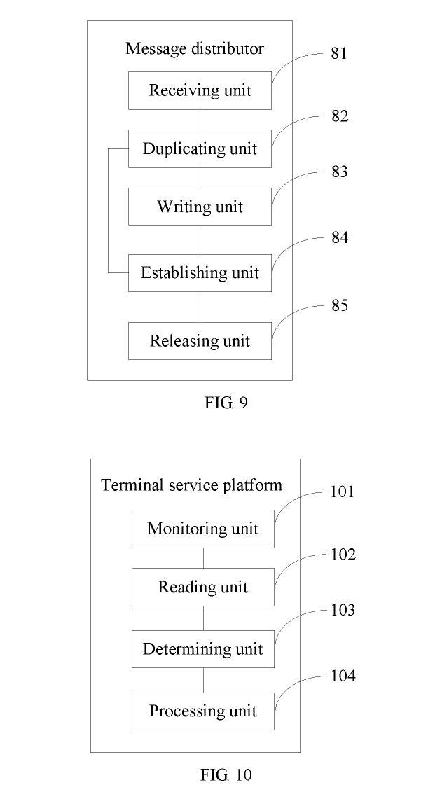

Further, another embodiment of the present disclosure further provides a terminal service platform. As shown in FIG. 10, the terminal service platform includes: a monitoring unit 101, a reading unit 102, a determining unit 103 and a processing unit 104, where

the monitoring unit 101 is configured to monitor whether an APP message is written into a message queue corresponding to the monitoring unit, the message queue is a data transmission channel, one end thereof is connected to the terminal service platform, and the other end is connected to a message distributor; the APP message is a copy of APP message written by the message distributor into each message queue connected to the message distributor through duplication after receiving the APP message sent by a message providing platform, where the APP message includes index information regarding to APP online or APP updating;

the reading unit 102 is configured to read the APP message out from the message queue when the monitoring unit 101 monitors that the APP message is written into the message queue connected to the monitoring unit;

the determining unit 103 is configured to determine whether the APP message read by the reading unit 102 to be an APP message required for the terminal service platform itself according to the index information; and

the processing unit 104 is configured to create or update an APP corresponding to the APP message according to a predetermined processing procedure of the terminal service platform when the determining unit 103 determines the APP message to be an APP message required for the terminal service platform itself.

Further, the index information in the APP message monitored by the monitoring unit 101 includes APP identification information and terminal service platform identification information.

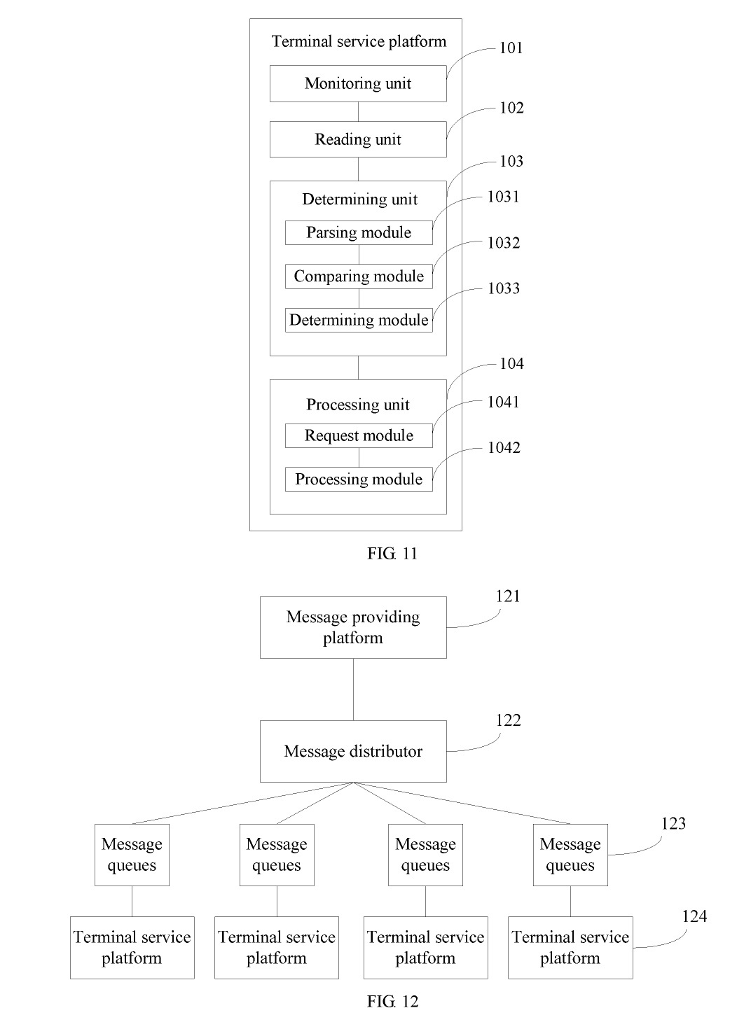

Further, as shown in FIG. 11, the determining unit 103 includes:

a parsing module 1031, configured to parse the APP message to acquire index information included in the APP message, where the index information includes the APP identification information and the terminal service platform identification information;

a comparing module 1032, configured to compare the terminal service platform identification information acquired by the parsing module 1031 with identification information of the terminal service platform itself; and

a determining module 1033, configured to determine the APP message to be an APP message required for the terminal service platform itself when the comparing module 1032 determines through comparison that the terminal service platform identification information is consistent with identification information of the terminal service platform, or determine the APP message not to be an APP message required for the terminal service platform itself when the comparing module 1032 determines through comparison that the terminal service platform identification information is inconsistent with identification information of the terminal service platform.

Further, as shown in FIG. 11, the processing unit 104 includes:

a request module 1041, configured to request to acquire APP Android application package APK information corresponding to the APP identification information according to the predetermined processing procedure of the terminal service platform; and

a processing module 1042, configured to perform online processing or updating on the APP corresponding to the APP identification information according to the APK information requested by the request module 1041.

Further, the processing unit 104 is configured to discard an APP message when the determining unit 103 determines the APP message not to be an APP message required for the terminal service platform itself.

Further, another embodiment of the present disclosure further provides a message distribution system, as shown in FIG. 12, the system includes: a message providing platform 121, a message distributor 122, message queues 123 and a terminal service platform 124, where

the message distributor 122 is the message distributor as shown in FIG. 8 or FIG. 9, and the terminal service platform 124 is the terminal service platform as shown in FIG. 10 or FIG. 11;

the message providing platform 121 is configured to generate an APP message and send the APP message to the message distributor 122; and

each message queue 123 has a unique identifier distinguishing from other message queues.

In this embodiment, a corresponding message queue is established for each terminal service platform, and when the message providing platform needs to send an APP message, a copy of identical APP message is directly sent by the message distributor to each message queue corresponding to a terminal service platform. This manner of sending an APP message to a message queue belongs to an indistinctive sending because an APP message can be sent to a connected message queue as long as the message queue is connected to the message distributor. Therefore, no attention needs to be paid to specific strategies such as a distribution object or a distribution manner when this message distribution method is used, and thus the message distribution method is simple and easy for operation, thereby avoiding a complex logic in sending an APP message by the message providing platform. Based on a fact that a message queue has a characteristic of message persistence, after an APP message is sent to a message queue, the APP message can be temporarily stored in each message queue. Each terminal service platform may monitor a message queue corresponding to the terminal service platform. Only when it is monitored that a message queue has an APP message is the APP message extracted from the message queue. Therefore, when an APP message is sent out but a corresponding terminal service platform works improperly and thus is unable to successfully receive the APP message, it is unnecessary to deploy complex strategies of message resending and message discarding or the like. In addition, when each terminal service platform monitors that a message queue corresponding to the terminal service platform has APP messages, the terminal service platform may recognize APP messages, and only process APP messages required for the terminal service platform. In this way, recognition and classification of APP messages are performed at the terminal service platform, which reduces a logic of distributing messages by the message providing platform to a certain extent. To sum up, compared with a synchronous distribution mechanism in the prior art, the present disclosure can greatly simplify a distribution logic for a distribution platform and implement a lightweight design of the distribution platform.

In this embodiment, after an APP message is sent to a message queue corresponding to each terminal service platform, the process is mutually independent for each terminal service platform to receive an APP message from a message queue corresponding to the terminal service platform. Each terminal service platform can flexibly determine message receiving time according to actual situation, and it is unnecessary for each terminal service platform to simultaneously start or finish receiving an APP message. Meanwhile, since each terminal service platform receives an APP message based on a message queue of its own, when certain a or a few terminal service platforms are in an unavailable state, this does not affect other terminal service platforms from normally receiving APP messages. In essence, independence and anti-interference in message receiving are greatly improved.

In addition, the method has following advantages:

1. Asynchronous characteristic: a distribution platform in the prior art uses a synchronous mechanism to distribute an APP message. The synchronous distribution mechanism may have two specific implementations: 1. establishing multithreading and sending messages to multiple terminal service platforms; 2. successively sending messages to each terminal service platform. When the quantity of terminal service platforms in the system increases, to a former implementation, concurrency resource cost of the distribution platform needs to increase; and to a latter implementation, message distributing time may be extended. In this method, establishment of a message queue can be implemented by means of simple method invocation, and message distribution for multiple message queues is performed concurrently. No matter how the quantity of terminal service platforms increases, the terminal service platform only needs to transmit an APP message once. Therefore, compared with the prior art, the method can greatly reduce concurrency resource cost and shorten distribution time consumption.

2. Flexibility: in the prior art, the distribution logic of the distribution platform needs to be changed if the quantity of terminal service platforms increases or decreases, which is complex and time-consuming in implementation, and message distribution has certain hysteresis. In the present disclosure, establishment and releasing of a message queue can be implemented by means of simple method invocation. Compared with the prior art, the method can flexibly and conveniently increase or decrease the quantity of terminal service platforms and ensure timely distribution of APP messages.

Further, an embodiment of the present disclosure further provides a non-transitory computer-readable storage medium storing executable instructions, which can be executed by an electronic device to perform any methods for message distribution mentioned by embodiments of the present disclosure.

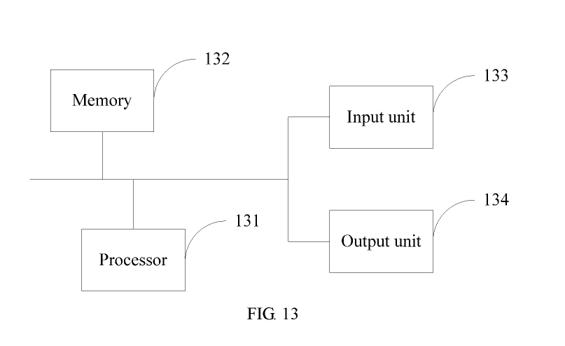

FIG. 13 is a block diagram of an electronic device which is configured to perform the methods for message distribution according to an embodiment of the present disclosure. As shown in FIG. 13, the device includes: one or more processors 131 and memory 132. A processor 131 is showed in FIG. 13 for an example.

Device which is configured to perform the methods for message distribution can also include: input unit 133 and output unit 134.

Processor 131, memory 132, input unit 133 and output unit 134 can be connected by BUS or other methods, and BUS connecting is showed in FIG. 13 for an example.

Memory 132 can be used for storing non-transitory software program, non-transitory computer executable program and modules as a non-transitory computer-readable storage medium, such as corresponding program instructions/modules for the methods for message distribution mentioned by embodiments of the present disclosure (such as shown in FIG. 8, receiving unit 81, duplicating unit 82, and writing unit 83). Processor 131 performs kinds of functions and data processing of the electronic device by executing non-transitory software program, instructions and modules which are stored in memory 132, thereby realizes the methods for message distribution mentioned by embodiments of the present disclosure.

Memory 132 can include program storage area and data storage area, thereby the operating system and applications required by at least one function can be stored in program storage area and data created by using the device for message distribution can be stored in data storage area. Furthermore, memory 132 can include high speed Random-access memory (RAM) or non-volatile memory such as magnetic disk storage device, flash memory device or other non-volatile solid state storage devices. In some embodiments, memory 132 can include long-distance setup memories relative to processor 131, which can communicate with the device for message distribution by networks. The examples of said networks are including but not limited to Internet, Intranet, LAN, mobile Internet and their combinations.

Input unit 133 can be used to receive inputted number, character information and key signals causing user configures and function controls of the device for message distribution. Output unit 134 can include a display screen or a display device.

The said module or modules are stored in memory 132 and perform the methods for message distribution when executed by one or more processors 131.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

Among the foregoing embodiments, description of various embodiments may be focused on differentially, and a part not expatiated in a certain embodiment may refer to related description of other embodiments.

Persons skilled in the art may clearly understand that for a convenient and concise description, a concrete work process of systems, devices and units described above may refer to a corresponding process of the foregoing method embodiments, which is not repeated anymore herein.

Algorithm and display provided herein are not inherently related to a particular computer, virtual system or other equipment. Various general systems may also be used with the teaching based on the disclosure. According to the above description, the required structure for constructing such a system is obvious. In addition, the disclosure is not directed to any particular programming language. It should be understood that a variety of programming languages can be used to implement the disclosed contents as described herein and above description to the particular programming language is to disclose the best inventive implementation mode.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

Similarly, it should be understood that, in order to simplify the disclosure and to facilitate the understanding of one or more of various aspects thereof, in the above description of the exemplary embodiments of the disclosure, various features of the disclosure may sometimes be grouped together into a single embodiment, accompanying figure or description thereof. However, the method of this disclosure should not be constructed as follows: the disclosure for which the protection is sought claims more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the disclosure.

It should be understood by those skilled in the art that modules of the device in the embodiments can be adaptively modified and arranged in one or more devices different from the embodiment. Modules, units or components in the embodiment can be combined into one module, unit or component, and also can be divided into more sub-modules, sub-units or sub-components. Except that at least some of features and/or processes or units are mutually exclusive, various combinations can be used to combine all the features disclosed in specification (including claims, abstract and accompanying figures) and all the processes or units of any methods or devices as disclosed herein. Unless otherwise definitely stated, each of features disclosed in specification (including claims, abstract and accompanying figures) may be taken place with an alternative feature having same, equivalent or similar purpose.

In addition, it should be understood by those skilled in the art, although some embodiments as discussed herein comprise some features included in other embodiment rather than other feature, combination of features in different embodiment means that the combination is within a scope of the disclosure and forms the different embodiment. For example, in the claims, any one of the embodiments for which the protection is sought can be used in any combination manner.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the parts in the title of disclosure (for example, a device for determining hyperlink ranks in a website) according to the embodiments of the disclosure. The disclosure may further be implemented as equipment or device program (for example, computer program and computer program product) for executing some or all of the methods as described herein. Such program for implementing the disclosure may be stored in the computer readable medium, or have a form of one or more signals. Such a signal may be downloaded from the Internet websites, or be provided on a carrier signal, or provided in any other form.

It should be noted that the above-described embodiments are intended to illustrate but not to limit the disclosure, and alternative embodiments can be devised by a person skilled in the art without departing from the scope of claims as appended. In the claims, no reference mark between round brackets shall impose restriction on the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be construed as naming.

What is claimed is:

1. A method for message distribution, implemented by a message distributor, comprising:
receiving an application APP message sent by a message providing platform, the APP message comprising index information regarding to APP online or APP updating; and
duplicating the received APP message, and writing a copy of the APP message into each message queue connected to the message distributor, the message queue being a data transmission channel, one end being connected to a terminal service platform, other end being connected to the message distributor, each terminal service platform separately acquiring the APP message from a message queue connected to the terminal service platform, and then determining, according to the index information, whether the APP message is an APP message required for the terminal service platform.

2. The method according to claim 1, wherein before duplicating the received APP message, and writing a copy of the APP message into each message queue connected to the message distributor, the method further comprises:
establishing a one-to-one corresponding binding connection between a terminal service platform and the message queue, and each message queue having a unique identifier distinguishing from other message queues.

3. The method according to claim 2, wherein the establishing a one-to-one corresponding binding connection between a terminal service platform and the message queue comprises:
initializing establishment of a binding connection with the message queue; and
adding establishment of a binding connection with the message queue.

4. The method according to claim 2, wherein the duplicating the received APP message, and writing the APP message into each message queue connected to the message distributor comprises:
fanning the APP message out to be multiple copies of identical APP messages through a fanout mode, wherein number of copies of the APP messages fanned out is equal to a quantity of message queues; and
separately writing a copy of the APP message into each message queue connected to the message distributor.

5. The method according to claim 2, wherein after a terminal service platform acquires the APP message from a message queue connected to the terminal service platform, the method also comprises:
releasing a binding connection between the terminal service platform and the message queue; and
establishing one-to-one corresponding binding connections between other terminal service platforms and the message queue.

6. The method according to claim 5, wherein after the establishing one-to-one corresponding binding connections between other terminal service platforms and the message queue, the method further comprises:
reduplicating the APP message, and writing the reduplicated APP message into the message queue so that the other terminal service platforms acquire the reduplicated APP message by means of the message queue.

7. The method according to claim 1, wherein the index information comprises APP identification information and terminal service platform identification information.

8. An electronic device, comprising:
at least one processor; and
a memory communicably connected with the at least one processor for storing instructions executable by the at least one processor, wherein execution of the instructions by the at least one processor causes the at least one processor to:
receive an application APP message sent by a message providing platform, the APP message comprising index information regarding to APP online or APP updating;
duplicate the APP message; and
write a copy of the duplicated APP message into each message queue connected to the message distributor, the message queue being a data transmission channel, one end being connected to a terminal service platform, other end being connected to the message distributor, each terminal service platform separately acquiring the APP message from a message queue connected to the terminal service platform, and then determining, according to the index information, whether the APP message is an APP message required for the terminal service platform.

9. The electronic device according to claim 8, wherein the instructions are executed to cause the at least one processor to:
establish a one-to-one corresponding binding connection between a terminal service platform and the message queue before duplicating the received APP message and writing a copy of the duplicated APP message into each message queue connected to the message distributor, and each message queue having a unique identifier distinguishing from other message queues.

10. The electronic device according to claim 9, wherein the instructions are executed to cause the at least one processor to:
initialize establishment of a binding connection with the message queue and add establishment of a binding connection with the message queue.

11. The electronic device according to claim 9, wherein the instructions are executed to cause the at least one processor to:
fan the APP message out to be multiple copies of identical APP messages through a fan-out mode, wherein number of copies of the APP messages fanned out is equal to a quantity of message queues; and
separately write a copy of the APP message into each message queue connected to the message distributor.

12. The electronic device according to claim 9, wherein the instructions are executed to cause the at least one processor to:
release a binding connection between the terminal service platform and the message queue after the terminal service platform acquires the APP message from a message queue connected to the terminal service platform; and
establish one-to-one corresponding binding connections between other terminal service platforms and the message queue.

13. The electronic device according to claim 12, wherein the instructions are executed to cause the at least one processor to:
reduplicate the APP message after establishing one-to-one corresponding binding connections between other terminal service platforms and the message queue; and
write the reduplicated APP message into the message queue so that the other terminal service platforms acquire the reduplicated APP message by means of the message queue.

14. An electronic device, comprising:
at least one processor; and
a memory communicably connected with the at least one processor for storing instructions executable by the at least one processor, wherein execution of the instructions by the at least one processor causes the at least one processor to:
monitor whether an APP message is written into a message queue, the message queue being a data transmission channel, one end being connected to the terminal service platform, other end being connected to a message distributor; the APP message being a copy of APP message written by the message distributor into each message queue connected to the message distributor through duplication after receiving the APP message sent by a message providing platform, wherein the APP message comprises index information regarding to APP online or APP updating;
read the APP message out from the message queue when monitoring that the APP message is written into the message queue;
determine whether the APP message read to be an APP message required for the terminal service platform according to the index information; and
create or update an APP corresponding to the APP message according to a predetermined processing procedure of the terminal service platform when determining the APP message to be an APP message required for the terminal service platform.

15. The electronic device according to claim 14, wherein the index information in the monitored APP message comprises APP identification information and terminal service platform identification information.

16. The electronic device according to claim 15, wherein the instructions are executed to cause the at least one processor to:
parse the APP message to acquire index information comprised in the APP message, the index information comprising the APP identification information and the terminal service platform identification information;
compare the terminal service platform identification information acquired by the parsing module with identification information of the terminal service platform; and
determine the APP message to be an APP message required for the terminal service platform when determining through comparison that the terminal service platform identification information is consistent with identification information of the terminal service platform, or determine the APP message not to be an APP message required for the terminal service platform when determining through comparison that the terminal service platform identification information is inconsistent with identification information of the terminal service platform.

17. The electronic device according to claim 16, wherein the instructions are executed to cause the at least one processor to:
request to acquire APP Android application package APK information corresponding to the APP identification information according to the predetermined processing procedure of the terminal service platform; and
perform online processing or updating on the APP corresponding to the APP identification information according to the requested APK information.

18. The electronic device according to claim 14, wherein the instructions are executed to cause the at least one processor to:
discard the APP message when determining that the APP message is not an APP message required for the terminal service platform.
